(19) United States
(12) Patent Application Publication
(10) Pub. No.: US 2015/0121456 A1
(43) Pub. Date: Apr. 30, 2015

(54) EXPLOITING TRUST LEVEL LIFECYCLE EVENTS FOR MASTER DATA TO PUBLISH SECURITY EVENTS UPDATING IDENTITY MANAGEMENT

(71) Applicant: International Business Machines Corporation, Armonk, NY (US)

(72) Inventors: Ivan M. Milman, Austin, TX (US); Martin A. OBERHOFER, Bondorf (DE); Miguel A. Ortiz, Austin, TX (US)

(73) Assignee: INTERNATIONAL BUSINESS MACHINES CORPORATION, Armonk, NY (US)

(21) Appl. No.: 14/063,170

(22) Filed: Oct. 25, 2013

(51) Int. Cl. H04L 29/06

(52) U.S. Cl. CPC H04L 63/10
USPC 726/3

(57) ABSTRACT

System, method, and computer program product to exploit trust level lifecycle events for master data to publish security events updating identity management, assigning, in a master data management (MDM) system, an initial trust level, to a first individual based on a level of association of the first individual with an entity owning the MDM system, the initial trust level corresponding to access rights in the MDM system, collecting data about the first individual from one or more social networking sites, computing a trust score for the first individual based on data pertaining to the first individual from the MDM system and the collected data, and updating the trust level for the first individual based on the trust score.

### BACKGROUND

The present disclosure relates to computer software, and more specifically, to computer software which exploits trust level lifecycle events for master data to publish security events updating identity management.

When relevant demographics about a person change, such as moving to a new employer, being fired from a current employer, or the person's sentiment about a company changing from positive to negative, significant security gaps may arise based on access to corporate IT assets the person had before the demographics changed. Currently, there are no methods to detect these changes and update privileges according to the changes.

### SUMMARY

Embodiments disclosed herein provide a system, method, and computer program product to exploit trust level lifecycle events for master data to publish security events updating identity management, assigning, in a master data management (MDM) system, an initial trust level, to a first individual based on a level of association of the first individual with an entity owning the MDM system, the initial trust level corresponding to access rights in the MDM system, collecting data about the first individual from one or more social networking sites, computing a trust score for the first individual based on data pertaining to the first individual from the MDM system and the collected data, and updating the trust level for the first individual based on the trust score.

### BRIEF DESCRIPTION OF THE SEVERAL VIEWS OF THE DRAWINGS

FIG. 1 is a system for exploiting trust level lifecycle events for master data to publish security events updating identity management, according to one embodiment.

FIG. 2 illustrates a logical view of components of a system for using trust level lifecycle events to implement identity management, according to one embodiment.

FIG. 3 illustrates a method for using trust level lifecycle events to implement identity management, according to one embodiment.

FIGS. 4A-4C illustrate a method to compute a trust score, according to one embodiment.

### DETAILED DESCRIPTION

A globally integrated company in the age of social media interacts with employees, subcontractors, business partner employees, customer employees, prospects, and analysts. Any number of relationships may exist between the company and people, as well as the business and other businesses. These relationships may change rapidly, and can result in number of concerns. When people change employers, for example, how should their level of access to information owned by the business change? What level of information should be provided to potential clients/customers/employees visiting the corporate website? What if an analyst having a high level of information access, based on previously posted positive reviews, begins posting negative reviews?

The challenge from an IT security perspective is improved identity management to provide the right level of access to different people, taking into account social interactions, analytics of social media, business/personal relationships, and the like. Depending on what is known or discovered about the person, a trust level can be incrementally increased or decreased to prevent security issues.

Embodiments disclosed herein provide a trust level life cycle for an identity computed and managed by a master data management (MDM) system. A trust level life cycle may include a number of different statuses, each representing a level of association between the user and the entity hosting the MDM system. As the relationship evolves over time, different levels of access rights and permissions may be granted to the user, or removed from his account. Embodiments disclosed herein implement and enforce rules on trust levels by emitting notifications to corporate security infrastructure when trust levels change. The corporate security infrastructure may adjust the corporate security infrastructure based on security policies associated with the notification types, resulting in the allowance and revocation of security privileges based on a new trust level.

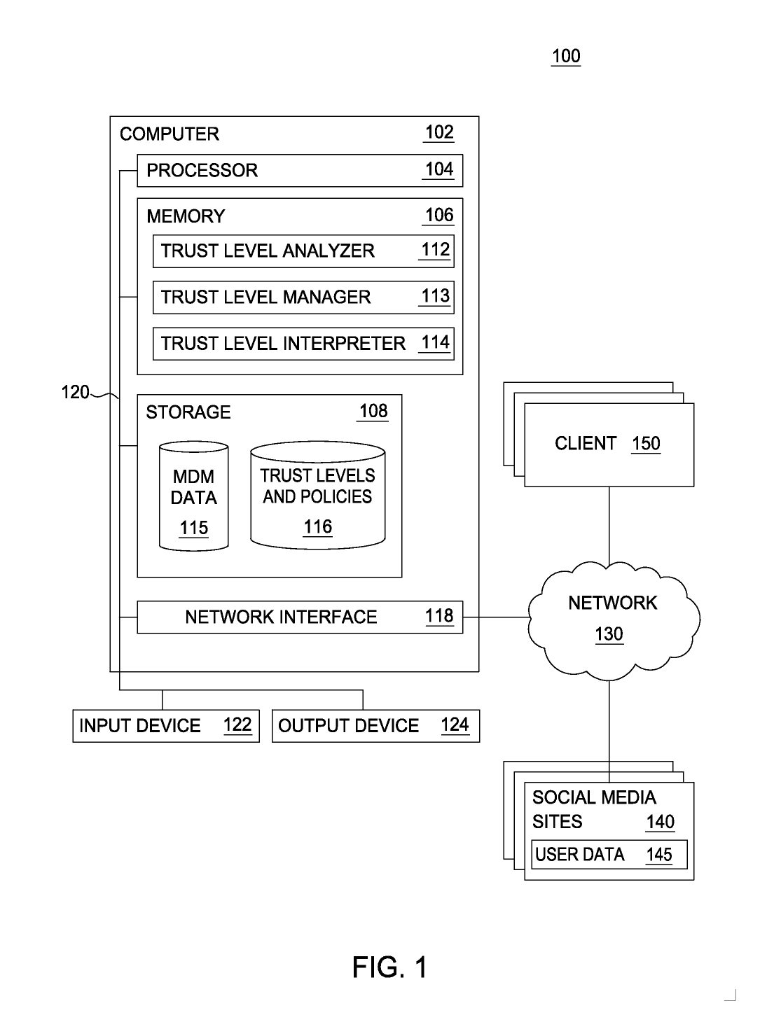

FIG. 1 is a system 100 for exploiting trust level lifecycle events for master data to publish security events updating identity management, according to one embodiment disclosed herein. The networked system 100 includes a computer 102. The computer 102 may also be connected to other computers via a network 130. In general, the network 130 may be a telecommunications network and/or a wide area network (WAN). In a particular embodiment, the network 130 is the Internet.

The computer 102 generally includes a processor 104 connected via a bus 120 to a memory 106, a network interface device 118, a storage 108, an input device 122, and an output device 124. The computer 102 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 104 is included to be representative of a single CPU, multiple CPUs, a single CPU having multiple processing cores, and the like. Similarly, the memory 106 may be a random access memory. While the memory 106 is shown as a single identity, it should be understood that the memory 106 may comprise a plurality of modules, and that the memory 106 may exist at multiple levels, from high speed registers and caches to lower speed but larger DRAM chips. The network interface device 118 may be any type of network communications device allowing the computer 102 to communicate with other computers via the network 130.

The storage 108 may be a persistent storage device. Although the storage 108 is shown as a single unit, the storage 108 may be a combination of fixed and/or removable storage devices, such as fixed disc drives, solid state drives, SAN storage, NAS storage, or optical storage. The memory 106 and the storage 108 may be part of one virtual address space spanning multiple primary and secondary storage devices.

The input device 122 provides input to the computer 102 such as a keyboard and a mouse. The output device 124 may provide output to a user of the computer 102. For example, the output device 124 may be any conventional display screen or set of speakers. Although shown separately from the input device 122, the output device 124 and input device 122 may be combined. For example, a display screen with an integrated touch-screen may be used.

As shown, the memory 106 contains a trust level analyzer 112. The trust level analyzer provides an application configured to implement social media analytics to determine a lifecycle status and a trust level of a person. For example, an unknown user newly registered in the system and having no social media data available may be given a low trust level score corresponding to the lowest possible trust level, as the trust level analyzer 112 is unable to discover any information indicating a sufficient level of trust necessary to grant greater access to a business or entity's information and resources. The memory 106 also includes a trust level manager 113, which is an application generally configured to implement rules on trust level changes. The trust level manager 113 determine whether to revise a user's trust level it may emit notifications to the corporate security infrastructure requesting to enforce the trust level rules by adding or removing privileges related to that user's account. For example, if a company's employee leaves for a rival competitor, his trust score may be significantly reduced, which results in a lower trust level. The trust level manager 113 may, upon detecting the lower trust level, may emit a notification to the trust level interpreter 114, which may take necessary actions to revoke the former employee's privileges. As shown, the memory 106 also includes the trust level interpreter 114, which may be a component of corporate security infrastructure infused with semantic knowledge to map trust level changes to the addition or removal of security privileges for an identity related to a person managed by the MDM system. Examples of corporate security infrastructure systems include lightweight directory access protocol (LDAP) software.

As shown, the storage 108 includes MDM data 115, which may include master data related to the operation of an enterprise. The MDM data 115 may include data records storing attributes related to a person, business, or other entity. Furthermore, the MDM data 115 may provide data model extensions storing trust level attributes used to manage the lifecycle of users. Example for such attributes could be an entity status with valid values such as anonymous, claimed, registered, trusted and authorized. Note that these valid values are by example only and are configurable. In one embodiment, an additional set of attributes might be marked as “critical data elements.” Critical data elements trigger events if the value of such an attribute changes. Such an event triggers the execution of event type specific logic. For example, if the attributes for relationship information are marked as critical data elements, an event could be registered that any service invocation of the addRelationship, updateRelationship, or removeRelationship services affects the trust level score and therefore the trust level rating for the associated master data entities should be re-assessed. In another embodiment, the data model extensions may include attributes such as valid from/valid to attribute pairs for certain attributes like relationships. Any service such as addRelationship, updateRelationship or removeRelationship services affecting the attributes valid from/valid to for relationship data is treated as trust level related and might cause a re-assessment of the trust level scores of the involved master data entities in the relationship. The MDM data 115 may also define roles for each person. As a working example, a set of rules may include a prospect, customer, business partner, employee, and contractor roles. A prospect may be a business prospect owned and managed by a marketing department, whose system access is restricted to marketing related services. A customer may be owned by a business unit, whose employees may be placed in an organization hierarchy of the customer (such as business unit hierarchy, geographic hierarchy, legal hierarchy, sales hierarchy, etc), and may have access to product support, call center, and other related services. The business partner may be owned by the business partner department, whose employees may be placed in an organization hierarchy of the customer (such as business unit hierarchy, geographic hierarchy, legal hierarchy, sales hierarchy, etc), and may have access to product support, call center, and other dedicated business partner channels. An employee record for an employee may be created and managed in an employee dictionary. The employee may have access rights defined by job roles and responsibilities. A contractor may be placed in the employee dictionary, but have limited access rights as compared to the employees.

The storage 108 also includes trust levels and policies 116, which may define a trust levels in the trust lifecycle, as well as security policies related to the trust levels. As a working example for discussion, five trust levels could be defined as anonymous, claimed, registered, trusted, and authorized trust level. Of course, any number of semantic definitions may be provided for the different trust levels. For example, an anonymous user may be a person or business for whom nothing is currently known about. A claimed user may be one with an account that is subject to user tracking, such as through cookies on the company web site, but no entry in an identity management system has been made. A registered user may be one registered with a valid email address and a person or organization record may have been made created in the MDM system. A trusted entity may be someone the business has had at least one interaction with, such as a meeting, call, chat, and for whom the MDM system has provisioned a corresponding identity. An authorized person may be someone the business has collected more personalized information for, or for whom the business has completed business process screening, or for whom a company threshold is exceeded, such that an identity management solution has authorized access with roles and privileges. In one embodiment, the trust levels are associated with a range of trust level scores. For example, if trust level scores range from 0-100, then a score of 0-20 may result in the anonymous trust level, a score of 21-40 may result in the claimed trust level, a score of 41-60 may result in the registered trust level, a score of 61-80 may result in the trusted trust level, and a score of 81-100 may result in the authorized trust level.

As shown, clients 150 may access services on the computer. For example, a client 150 may access a corporate website hosted on the computer 102, and create a user account. When the user account is created, the trust level analyzer 112 may access user data 145 on a plurality of social media sites 140 in order to compute the trust level score for the user. Any suitable method may be used to access the user data, including the user's email address or name.

Although depicted as residing on a single server, any configuration of the trust level analyzer 112, trust level manager 113, trust level interpreter 114, MDM data 114, and trust levels and policies on one or more computers is contemplated. Furthermore, the components may be realized within software, hardware, or a combination thereof. For example, the trust level analyzer 112, trust level manager 113, and trust level interpreter 114 may each be standalone applications, or components of a single application.

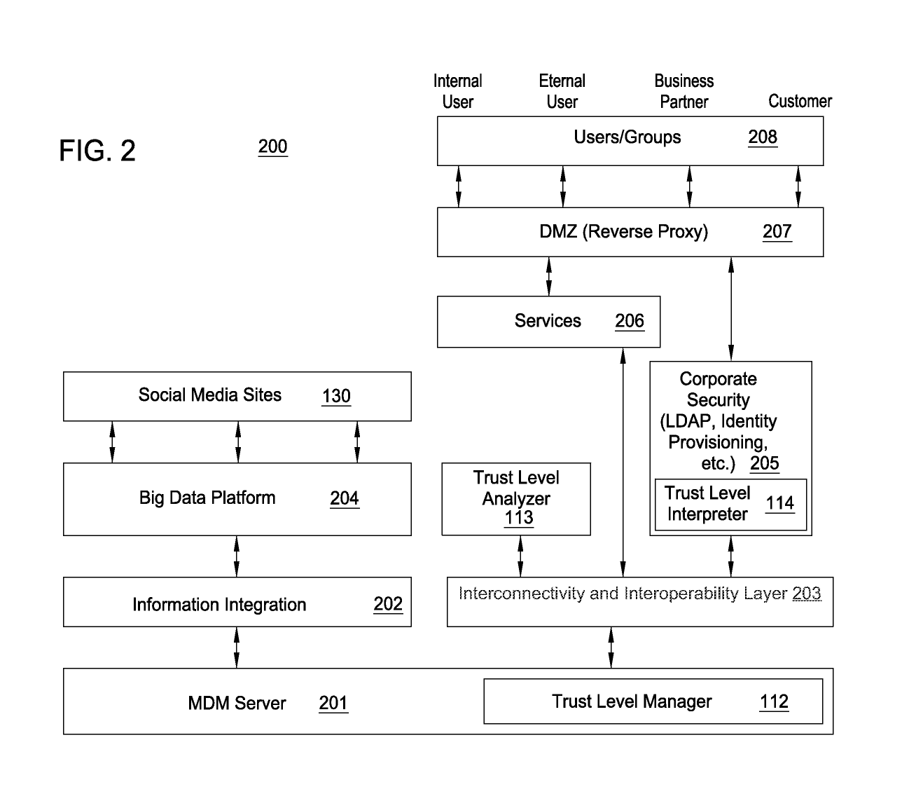

FIG. 2 is a logical view of components 200 of a system for using trust level lifecycle events to implement identity management, according to one embodiment disclosed herein. A master data management (MDM) server 201 provides master data management services to manage master data related to the different enterprises and individuals interacting with the enterprise owning the MDM system. As shown, the MDM server also includes the trust level manager 112. The trust level manager 112 operates on data model extensions storing trust level attributes that may be used to manage the trust level lifecycle of the user. The data model extensions include attributes allowing the system to determine whether a specific service invocation is related to trust level activities. An information integration component 202 provides batch integration and cleansing data from a big data platform 204. The big data platform 204 may be configured to perform social media analytics consuming social media data from a plurality of social media platforms, such as the social media sites 140. In one embodiment, the trust level analyzer 113 may reside in the big data platform 204. An Interconnectivity and Interoperability Layer 203 may provide for near real-time and real-time integration between the MDM server 201 and services 206. One example of an Interconnectivity and Interoperability Layer is an enterprise service bus (ESB). A corporate security system 205 provides necessary security services, such as identity provisioning and management, authentication, authorization, and identity stores. In one embodiment, the trust level interpreter 114 resides in the corporate security system 205.

Services 206 may include both internal and external services and systems, such as ecommerce, corporate internet portals, in-house applications such as SAP ERP, mobile channels, and the like. These applications may be used by internal users, external users, business partners, and customers. A demilitarized zone (DMZ) 207 with reverse proxy patterns may be used to secure access to all applications and services 206 for all user types. A users/groups 208 may represent all entities that interact with the organization.

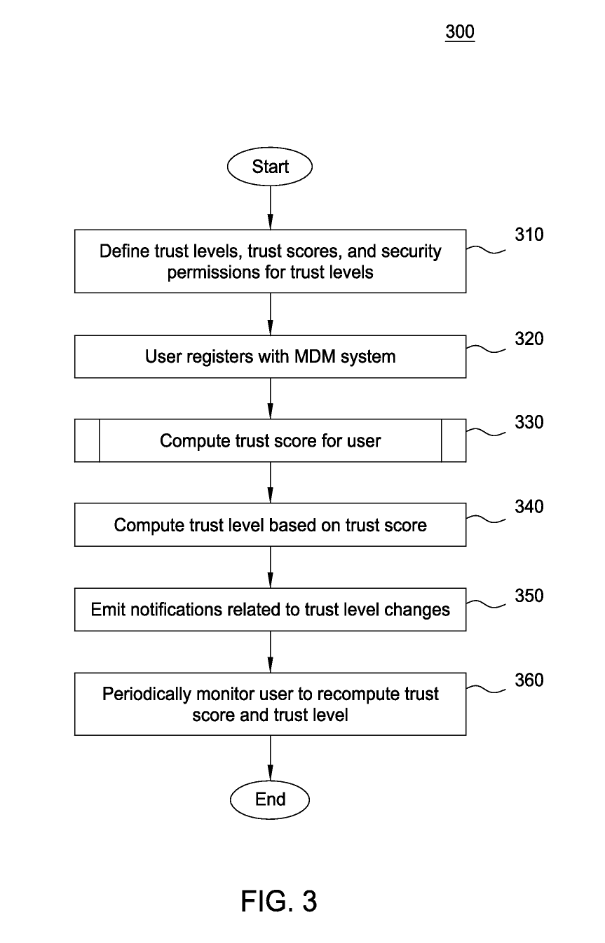

FIG. 3 illustrates a method 300 for using trust level lifecycle events to implement identity management, according to one embodiment disclosed herein. In one embodiment, the trust level analyzer 112, trust level manager 113, and trust level interpreter 114 may execute of the steps of the method 300. At step 310, trust levels, trust scores, and security permissions for the trust levels may be defined. In one embodiment, the trust levels, trust scores, and security permissions may be predefined and retrieved from storage or memory. Continuing with the above example, 5 trust levels, including anonymous, claimed, registered, trusted, and authorized may be defined. The trust scores may be mapped to trust levels. For example, if trust level scores range from 0-100, then a score of 0-20 may result in the anonymous trust level, a score of 21-40 may result in the claimed trust level, a score of 41-60 may result in the registered trust level, a score of 61-80 may result in the trusted trust level, and a score of 81-100 may result in the authorized trust level. The security permissions may be related to any component of security settings such as permissions to view files, create files, access services and resources, and the like.

At step 320, a user registers with the MDM system of a given organization. In one embodiment, the registration may be an external user registering with an email address and a password. The external user's registration may cause the MDM system invoke a create person/create organization service, creating a new master data entity record. In an alternative embodiment, a new employee may use an internal website to create a single sign on (SSO) user ID, e.g., based on the employee's internal email address and password. Creating the SSO may invoke a service of the MDM system to create new records in cases where the employee's information is not already in the MDM system. If the employee's core information is in the MDM system, then an MDM update person service may be invoked. In either embodiment, the MDM services used may cause the trust level manager 113 to trigger a check to recognize that the service calls in question are trust level related, and by having at least one email address and a password hash as part of the incoming service, would identify the service request to be a registration trust level activity. The trust level manager 113 may create an identity provisioning event with the necessary user information (email address, password hash, etc.) emitted to the corporate security system 205 through the Interconnectivity and Interoperability Layer 203. The corporate security system 205 provisions the necessary security capabilities for the new user ID. As part of the user registration the trust level manager 113 may trigger, at step 330, a social media analysis for the new or updated person record to compute a trust score for the user. The MDM services triggered by the user registration at step 320 may conclude after the identity provisioning event has been emitted. However, the password hash may not be stored within the MDM system for security reasons, while other information such as email address, name, etc may be stored within the MDM system. Additionally, the trust level manager 113 may set the newly registered user's trust level to registered (or any other level) but with a verification pending status until the social media analytics component used in generating the trust score has not been completed. In addition to assigning the initial trust level prior to computing the trust score in conjunction with the social media analysis at step 330, the trust level manager 113 may assign a default trust score to the user at step 320.

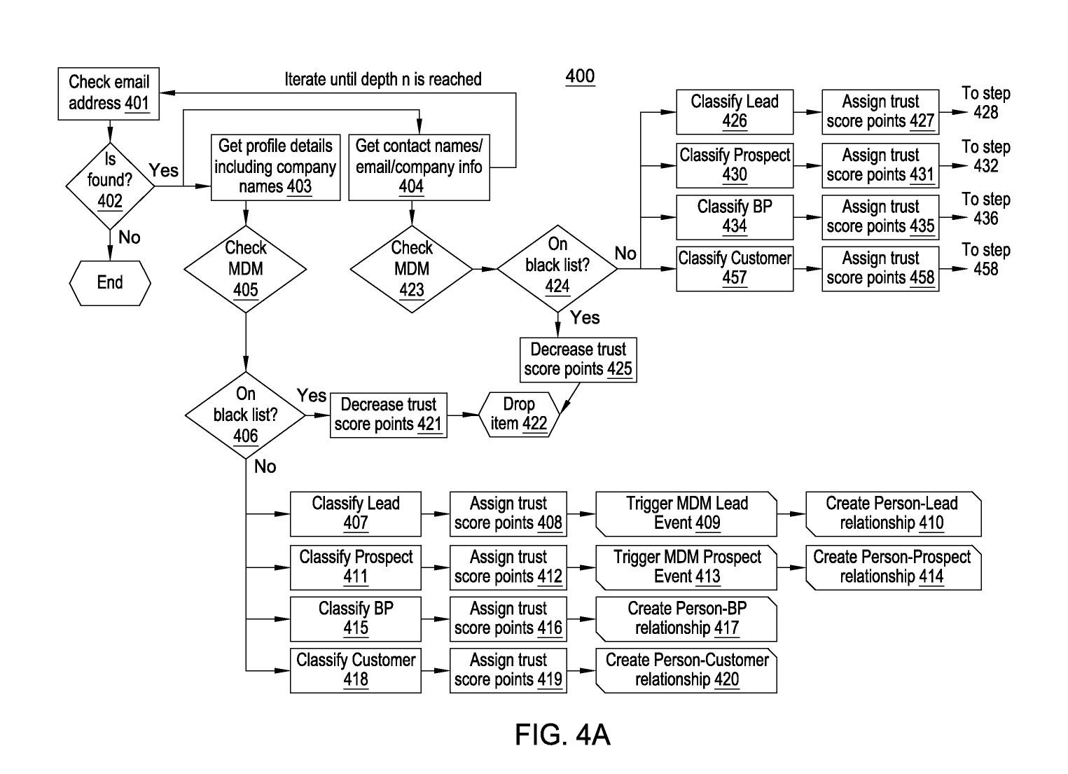

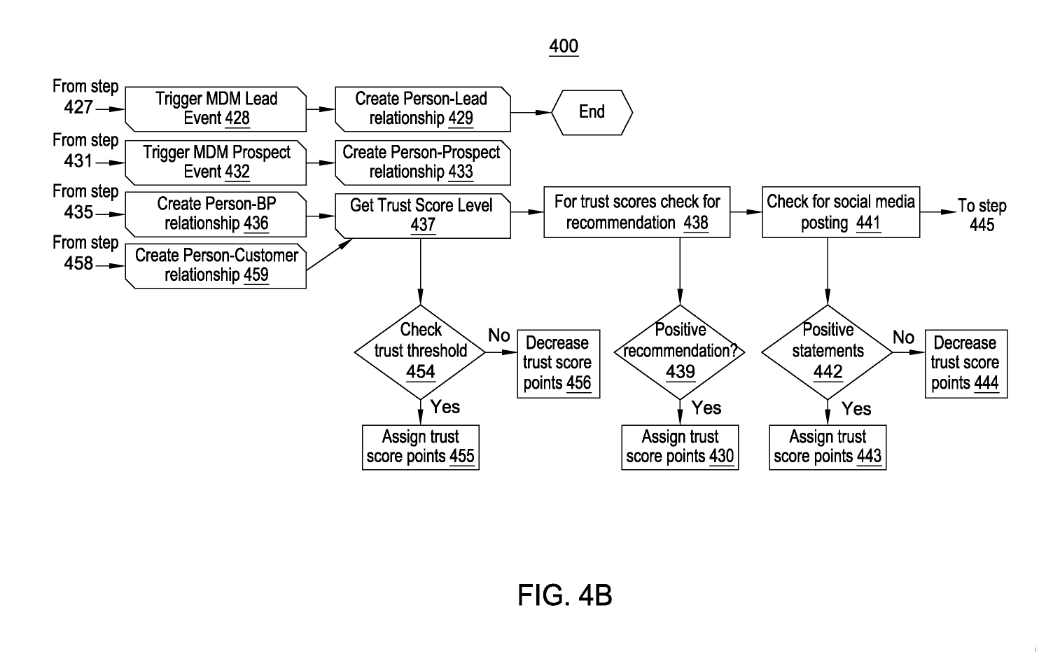

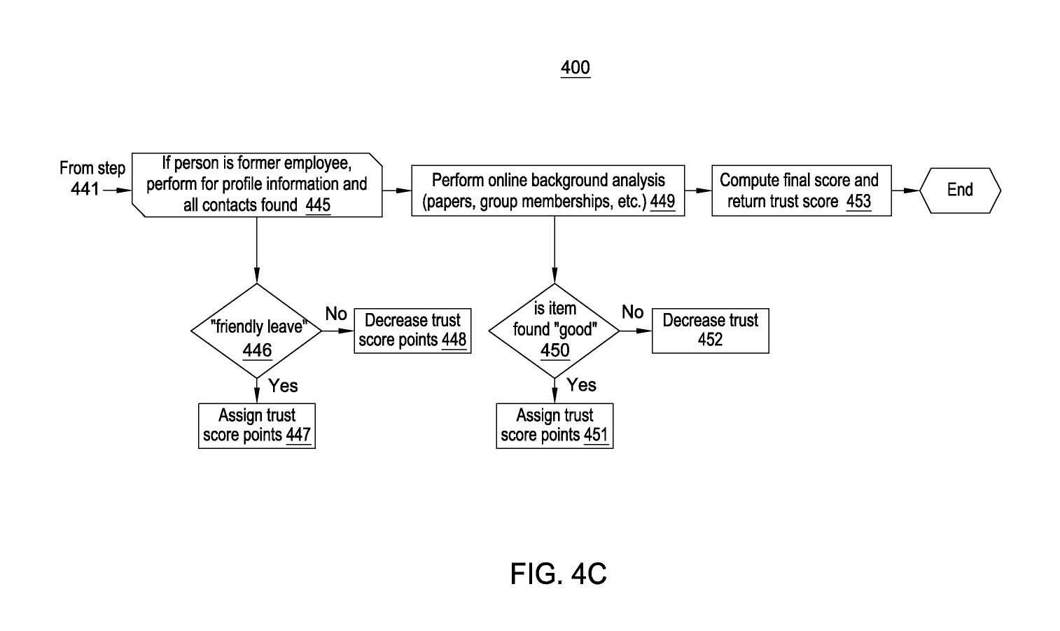

At step 330, the trust level analyzer 112 may compute a trust score for the user. Computing the trust score is explained in further detail below with reference to FIG. 4. Generally, the trust score may be computed based on an analysis of social media and other data to answer questions regarding the user, the user's contacts, and the contacts' organizations. When the user registers with an email address, the trust level analyzer 112 may determine whether the email address is registered on social networking sites, and whether any additional information, such as a name, address, age, phone number, etc., may be found on the social networking sites. If a match is found, a matching request in the MDM system may be triggered. If a match is found, the email address may be added to the existing entity as part of a collapse. If a match is found for two or more MDM records, the collapse operation merges these duplicate records usually into one survivor record comprised of the combined information of the duplicate records. If the email address is not found, the user data may be enriched with the personal information received from the social media data. If a match is found, the trust level analyzer 112 may also determine whether a company name can be identified based on the email address. If so, the trust level analyzer 112 may determine the relationship between the identified company and the entity, such as whether it is a prospect, customer, or business partner.

If the user is found on a social networking site, the trust level analyzer 112 may analyze each of the user's contacts to determine if they are known (i.e., identified in the MDM system), and if so, what their affiliation with the entity is, such as whether they are a prospect, business partner, or customer. Additionally, the trust level analyzer 112 may determine the average trust score for known social network contacts, the highest/lowest trust score of the contacts, and whether the contacts with higher trust levels have written recommendations for the user. Furthermore, any organizations the contacts are associated with may be analyzed to determine their relationship with the entity, such as whether they are prospects, business partners, or customers. The trust level analyzer 112 may also determine whether any person or organization related to the user is the owner of an email address on one or more black lists, such as the Office of Foreign Assets Control (OFAC) black list.

The trust level analyzer 112 may also analyze blogs, forum posts, tweets, and other online or digital publications of the user (and his or her contacts), to identify relevant statements made about the entity. For example, if the user makes positive or negative statements about the entity's top selling product, these statements may be used in raising or lowering the user's trust score. The trust level analyzer 112 may also determine whether the user is a former employee of the entity and, if so, an exit status. The trust level analyzer 112 may also determine what online groups the user is a member of, as well as what articles, books, research papers, and other publications the user has made.

The trust level analyzer 112 uses the results to these inquiries to determine a weighted trust score based on ranges that are correlated with trust levels. Based on the trust level corresponding to the trust score, an initial trust level may be assigned to the user. The initial level may be updated or refined over time by recomputing the trust score on predefined intervals. In one embodiment, the higher the user's trust level, the more frequently the trust score (and trust level) may be recomputed.

At step 340, a trust level may be assigned to the user based on the computed trust score. In one embodiment, the trust score is correlated to a trust level. Therefore, the computed trust score may fall into a range which indicates the trust level which should be assigned to the user. If, for the new user, the computed trust score still falls into the category of “registered,” as initially assigned, then the updated trust level may remain “registered,” however the status may be changed from “verification pending” to “confirmed.” In addition, a periodic event specifying a period re-evaluation of the trust score may be registered, such that the trust score is updated periodically, such as daily, weekly, monthly, etc. At step 350, notifications the trust level manager 113 emits notifications based on trust level changes. For example, if the new user's trust score falls into a category lower than the initially assigned “registered” level, the trust level manager 113 may emit an event for the trust level interpreter 114 to reduce or remove rights accordingly. If the trust score for the new user falls into a category higher than the initial “registered” level, then the trust level manager 113 may issue an event for the trust level interpreter to cause the corporate security 205 to increase the user's access rights accordingly. At step 360, the trust level analyzer 112 may periodically monitor data of the user (and all users) to recompute the trust score (and corresponding trust level) of the user. The trust score can be recomputed at predefined intervals or a user may specify to recompute the trust score. In one embodiment, the time intervals for recomputing the trust score are shorter for higher trust scores. Based on the updated trust scores and trust levels, the trust level manager 113 may emit notifications to the trust level interpreter 114 as described above.

FIG. 4A illustrates a method 400 to compute a trust score, according to one embodiment. In one embodiment, the trust level analyzer 112, trust level manager 113, and trust level interpreter 114 may orchestrate execution of the steps of the method 400. The method 400 is but one embodiment of the disclosure, as many different algorithms may be implemented to compute a trust score. For example, while the method 400 includes example categories for classification at steps 426, 430, 434, and 457 (and related follow-up steps), the method 400 may include more or less categories in different embodiments. As discussed above, the trust level analyzer 112 at step 401 checks an email address provided by the user. At step 402, the trust level analyzer determines whether it is found in the MDM system. If the email address is not found, the method 400 ends. If found, the trust level analyzer 112 proceeds to step 403, and retrieves social media profile details including the names of companies the user is associated with from the social media sites. In addition, at step 404, the trust level analyzer 112 retrieves names, email addresses, and company information for any contacts the user may have on social network sites. The steps 401-404 may be iterated until depth n is reached, where n is a degree for which one or more contacts or businesses are discovered relative to the user. For example, first, second, third level contacts may be analyzed for the user, even though the second and third level contacts may only be indirectly associated with the user. Therefore, for each contact found in social media in the previous iteration, matching procedures in MDM are triggered to discover if the companies/persons found on social media related to the email address for which the search was triggered. In the first iteration, this may mean that for all contacts and company names found related to the email address for which the process was initiated, a matching exercise against MDM would be performed. In subsequent iterations, this may be performed for contact/company names of the previous iteration until the depth is reached.

At step 405 and step 423, the trust level analyzer 112 checks MDM data for the user, his contacts, and companies associated with the user or contacts. At steps 406 and 424, the trust level analyzer 112 determines whether the user, his contacts and any of the associated business/companies are on a black list. If so, the user's trust score is decreased by a predefined number of points at steps 421 and 425, and at step 422, a drop item event notification may be emitted to have the user dropped from the MDM system. A drop can be achieved in one of multiple ways: in one embodiment, a logical delete in the MDM and the LDAP system can be done effectively deactivating the record. In another embodiment, the record might be physically removed in case of a drop event from the MDM and the LDAP system and moved to an archive where the record is stored for a while for compliance reasons.

Checking MDM data at steps 405 and 424, allows the trust level analyzer 112 to determine what type of entity the person or organization is relative to the entity owning the MDM system. For example, the user, contacts, and any affiliated organizations may be classified as leads, prospects, business partners, and customers. Regardless of the classifications, a series of workflows may be triggered once the category is identified. If the user (or one of his contacts at iteration n of the method 400) is associated with an entity classified as a lead at step 407, trust score points will be assigned to the user based on a predefined number of trust score points allocated for being associated with a business lead. At step 409, an MDM lead event may be triggered, which results in the creation of a person-lead relationship at step 410 between a marketing employee and the lead record. If the user is classified as a prospect at step 411, trust score points will be assigned to the user based on a predefined number of trust score points allocated for being a prospect at step 412. At step 413, an MDM prospect event may be triggered, which results in the creation of a person-prospect relationship at step 414—for example between a sales employee and the prospect record. If the user is associated with an entity classified as a business partner at step 415, trust score points will be assigned to the user based on a predefined number of trust score points allocated for being associated with a business partner at step 416. At step 417 a person-business partner relationship may be created. If the user is associated with an entity classified as a customer at step 418, trust score points will be assigned to the user based on a predefined number of trust score points allocated for being associated with ac customer at step 419. At step 420 a person-customer relationship may be created. Generally, any number of points may be assigned to the user based on the type of relationship with the entity owning the MDM system. For example, since customers may be more trusted than prospects, more trust score points may be allocated to the user at step 419 than at step 412.

Returning to step 424, if the discovered contacts and companies related to the user are not on a black list, these entities may be similarly classified based on their relationship to the MDM system owner. If the contact is classified as a lead at step 426, trust score points will be assigned to the user based on a predefined number of trust score points allocated for being associated with a lead at step 427. At step 428, shown on FIG. 4B, an MDM lead event may be triggered, which results in the creation of a person-lead relationship at step 429, and the end of this iteration of the method 400. If the contact is classified as a prospect at step 430, trust score points will be assigned to the user based on a predefined number of trust score points allocated for being associated with a prospect at step 431. At step 432, depicted on FIG. 4B, an MDM prospect event may be triggered, and a person-prospect relationship may be created at step 433. The method then proceeds to step 437. If the contact is classified as a business partner at step 434, trust score points will be assigned to the user based on a predefined number of trust score points allocated for being associated with a prospect at step 435. At step 436 a person-business partner relationship may be created. The method then proceeds to step 437. If the contact is classified as a customer at step 457, trust score points will be assigned to the user based on a predefined number of trust score points allocated for being associated with a customer at step 458. At step 459, shown on FIG. 4B, a person-customer relationship may be created in the MDM system. The method then proceeds to step 437, where the current trust score for the contact or associated organization is retrieved from the MDM system, to determine whether the found contact or organization is trustworthy. At step 454, the trust level analyzer 112 may determine whether the contact or organization has a trust score exceeding a trust level threshold. If the trust score exceeds a trust level threshold, the trust level analyzer 112 assigns additional trust score points at step 455. If the trust threshold is not met (or falls below a separate non-trustworthy threshold), the trust level analyzer 112 may decrease trust score points at step 456.

At step 438, the trust level analyzer 112 determines whether the contact or organization discovered has provided a recommendation for the user. If a recommendation is found, the sentiment of the recommendation may be analyzed at step 439. If the sentiment is positive, then trust score points may be assigned to the user at step 430. At step 441, the trust level analyzer 112 may search for social media posts (of the user and degree n contacts) to determine, at step 442, whether the statements are positive regarding the entity owning the MDM system. For example, the user (or his contacts of degree n) may write reviews of the entity's top selling product that may be analyzed by the trust level analyzer 112. If the statements are positive, then trust score points for the user may be added at step 443. If the statements are negative, the user's trust score may be decreased at step 444. For example, if the user has multiple reviews, blog posts, and social media posts disparaging the top selling product, then this person's trust score may be reduced for each negative publication.

At step 445, depicted on FIG. 4C, the trust level analyzer 112, performs additional analysis if the initial email address (or contact email addresses at depth n) were found in the MDM system and the MDM system indicates (through an employee database, for example) the person was a former employee. At step 446, the trust level analyzer 112 determines whether the employee left the company on good terms (i.e., was a “friendly” separation). If the employee left on good terms, then the trust level analyzer 112 may assign positive trust score points at step 447. If the employee did not leave on good terms, the trust level analyzer 112 may reduce trust score points at step 448.

At step 449, the trust level analyzer 112 may perform an online background analysis of the user. This may include an analysis of publications of the user, group memberships, social media posts, and the like. At step 450, the trust level analyzer 112 analyzes each item found at step 449 to determine the sentiment or overall effect of the discovered item. If the item is “good,” then trust score points may be added to the user's trust score at step 451. For example, if the user publishes positive product reviews and shares links to the product website, the user's trust score may be increased. If the item is not “good,” then trust score points may be decreased at step 452. For example, if the user authors a scholarly paper disparaging the work of top researchers in the company (hosting the MDM system), then the user's trust score may be reduced. At step 453, the trust level analyzer 112 computes and returns the user's final trust score.

Advantageously, embodiments disclosed herein utilize a wide range of information to compute a trust score for a user in an MDM system, and assign the user a trust level corresponding to the trust score. The different trust levels each include respective permissions, access rights, and other security related settings. Generally, the trust score is based on an analysis of known data about the user as well as data collected from social networking sites and the Internet at large. If positive or negative items of information are discovered, the trust score may be increased or decreased accordingly. Additionally, embodiments disclosed herein extend the analysis to contacts and organizational affiliations of the user. For example, if one or more of the user, his contacts, and their contacts are associated with a competitor, the user's trust score points may be reduced or increased depending on the nature of the relationship with the competitor (whether the two companies are on friendly or unfriendly terms).

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications for trust level lifecycle management or related data available in the cloud. For example, the trust level lifecycle applications could execute on a computing system in the cloud. In such a case, the trust level lifecycle applications could compute trust scores and trust levels for users and store the trust levels and trust scores at a storage location in the cloud. Doing so allows a user to access this information from any computing system attached to a network connected to the cloud (e.g., the Internet).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method, comprising:
assigning, in a master data management (MDM) system, an initial trust level, to a first individual based on a level of association of the first individual with an entity owning the MDM system, the initial trust level corresponding to access rights in the MDM system;
collecting data about the first individual from one or more social networking sites;
computing a trust score for the first individual based on data pertaining to the first individual from the MDM system and the collected data and by operation of one or more computer processors; and
updating the trust level for the first individual based on the trust score.

2. The method of claim 1, wherein the initial trust level is assigned to the first individual in response to the first individual registering with the MDM system, the method further comprising:
upon determining that the updated trust level is different from the initial trust level, updating the security settings for the first individual based on the updated trust level.

3. The method of claim 1, further comprising:
identifying a second individual having a relationship to the first individual;
collecting data about the second individual from the one or more social networking sites;
updating the trust score for the first individual based on data pertaining to the second individual from the MDM system and the collected data about the second individual; and
updating the updated trust level of the first individual based on the updated trust score.

4. The method of claim 1, wherein the trust score and the updated trust level are periodically recomputed based on predefined timing intervals, wherein the predefined timing intervals are shorter for a higher trust level relative to a lower trust level.

5. The method of claim 1, wherein the data pertaining to the first individual from the MDM system and one or more social networking sites comprises: (i) a recommendation, (ii) a sentiment of one or more items of data from the one or more social networking sites, (iii) leaving a former employer on positive terms, (iv) one or more items of third party reference data, (v) one or more items of data from one or more data sources of the entity owning the MDM system, and (vi) one or more publications of the first individual.

6. The method of claim 1, further comprising:
updating the trust score based on an iterative analysis of data pertaining to one or more individuals having an indirect relationship with the first individual from the MDM system and one or more social networking sites.

7. The method of claim 1, wherein each trust level is defined by a range of trust score points, wherein a notification specifying to update the security settings for the first individual emitted upon determining that the updated trust level is different than the initial trust level.

8. A system, comprising:
one or more computer processors; and
a memory containing a program which when executed by the one or more computer processors, performs an operation, the operation comprising:
assigning, in a master data management (MDM) system, an initial trust level, to a first individual based on a level of association of the first individual with an entity owning the MDM system, the initial trust level corresponding to access rights in the MDM system;
collecting data about the first individual from one or more social networking sites;
computing a trust score for the first individual based on data pertaining to the first individual from the MDM system and the collected data and by operation of one or more computer processors; and
updating the trust level for the first individual based on the trust score.

9. The system of claim 8, wherein the initial trust level is assigned to the first individual in response to the first individual registering with the MDM system, the operation further comprising:
upon determining that the updated trust level is different from the initial trust level, updating the security settings for the first individual based on the updated trust level.

10. The system of claim 8, the operation further comprising:
identifying a second individual having a relationship to the first individual;
collecting data about the second individual from the one or more social networking sites;
updating the trust score for the first individual based on data pertaining to the second individual from the MDM system and the collected data about the second individual; and
updating the updated trust level of the first individual based on the updated trust score.

11. The system of claim 8, wherein the trust score and the updated trust level are periodically recomputed based on predefined timing intervals, wherein the predefined timing intervals are shorter for a higher trust level relative to a lower trust level.

12. The system of claim 8, wherein the data pertaining to the first individual from the MDM system and one or more social networking sites comprises: (i) a recommendation, (ii) a sentiment of one or more items of data from the one or more social networking sites, (iii) leaving a former employer on positive terms, (iv) one or more items of third party reference data, (v) one or more items of data from one or more data sources of the entity owning the MDM system, and (vi) one or more publications of the first individual.

13. The system of claim 8, the operation further comprising:
updating the trust score based on an iterative analysis of data pertaining to one or more individuals having an indirect relationship with the first individual from the MDM system and one or more social networking sites.

14. The system of claim 8, wherein each trust level is defined by a range of trust score points, wherein a notification specifying to update the security settings for the first individual emitted upon determining that the updated trust level is different than the initial trust level.

15. A computer program product, comprising:
a computer-readable storage medium having computer-readable program code embodied therewith, the computer-readable program code comprising:
computer-readable program code configured to assign, in a master data management (MDM) system, an initial trust level, to a first individual based on a level of association of the first individual with an entity owning the MDM system, the initial trust level corresponding to access rights in the MDM system;
computer-readable program code configured to collect data about the first individual from one or more social networking sites;
computer-readable program code configured to compute a trust score for the first individual based on data pertaining to the first individual from the MDM system and the collected data; and
computer-readable program code configured to update the trust level for the first individual based on the trust score.

16. The computer program product of claim 15, wherein the initial trust level is assigned to the first individual in response to the first individual registering with the MDM system, the computer-readable program code further comprising:
computer-readable program code configured to, upon determining that the updated trust level is different from the initial trust level, update the security settings for the first individual based on the updated trust level.

17. The computer program product of claim 15, the computer-readable program code further comprising:
computer-readable program code configured to identify a second individual in the MDM system having a relationship with the first individual;
computer-readable program code configured to collect data about the second individual from the one or more social networking sites;
computer-readable program code configured to update the trust score for the first individual based on data pertaining to the second individual from the MDM system and the collected data about the second individual; and; and
computer-readable program code configured to update the updated trust level of the first individual based on the updated trust score.

18. The computer program product of claim 15, wherein the trust score and the updated trust level are periodically recomputed based on predefined timing intervals, wherein the predefined timing intervals are shorter for a higher trust level relative to a lower trust level.

19. The computer program product of claim 15, wherein the data pertaining to the first individual from the MDM system and one or more social networking sites comprises: (i) a recommendation, (ii) a sentiment of one or more items of data from the one or more social networking sites, (iii) leaving a former employer on positive terms, (iv) one or more items of third party reference data, (v) one or more items of data from one or more data sources of the entity owning the MDM system, and (vi) one or more publications of the first individual.

20. The computer program product of claim 15, wherein each trust level is defined by a range of trust score points, wherein a notification specifying to update the security settings for the first individual emitted upon determining that the updated trust level is different than the initial trust level, wherein the computer-readable program code further comprises:
computer-readable program code configured to update the trust score based on an iterative analysis of data pertaining to one or more individuals having an indirect relationship with the first individual from the MDM system and one or more social networking sites.
